(19) United States
(12) Patent Application Publication
(10) Pub. No.: US 2016/0307707 A1
(43) Pub. Date: Oct. 20, 2016

(54) METHOD FOR MANUFACTURING AN ELECTRODE FOR ENERGY STORAGE DEVICES AND AN ELECTRODE MANUFACTURED THEREWITH

(71) Applicant: YUNASKO, Ltd., London (GB)

(72) Inventors: Andriy ZHYKHAREV, Petropavlivska Borshchahivka (UA); Andrey MALETIN, Kiev (UA)

(73) Assignee: YUNASKO, Ltd., London (GB)

(21) Appl. No.: 15/099,669

(22) Filed: Apr. 15, 2016

Related U.S. Application Data
(60) Provisional application No. 62/149,483, filed on Apr. 17, 2015.

(51) Int. Cl. H01G 11/86; H01G 11/36; H01G 11/42; B05D 1/12

(52) U.S. Cl. CPC H01G 11/86; B05D 1/12; H01G 11/36; H01G 11/42

(57) ABSTRACT

Disclosed is a method for manufacturing an electrode for an energy storage device, including the steps of: (a) preparing a dry mixture of active electrode materials, for example nanoporous carbon and/or metal oxide powder, and a binder; (b) injecting the dry mixture into a carrying gas flow to form a jet of particles from a nozzle; (c) applying a high DC voltage between the nozzle and a substrate to create a high electrostatic field that provides a dense deposition of the dry mixture onto a substrate surface.

### CROSS-REFERENCE TO RELATED APPLICATIONS

This application claims priority from U.S. Provisional Application No. 62/149,483, filed on Apr. 17, 2015 and entitled “A method for manufacturing an electrode for energy storage devices and an electrode manufactured therewith”, the contents of which are hereby incorporated herein in their entirety by reference thereto.

### FIELD

The present teachings pertain to electrodes for energy storage devices and to a method for manufacturing such electrodes. In particular, the present teachings pertain to a method of applying an active electrode layer onto a metal current collector surface, and thus forming an electrode for electrochemical double layer capacitors (EDLC's) or various hybrid devices.

### BACKGROUND

Electrochemical double layer capacitors (EDLCs), also known as ultracapacitors or supercapacitors, are efficient energy storage devices. A typical EDLC comprises at least one electrode made of a nanoporous carbon material. A second electrode can be made either of a similar nanoporous carbon material, in so-called symmetrical EDLC devices, or of a different material, e.g. of a metal oxide known in battery technology arts, in so-called asymmetrical or hybrid devices. In some hybrid device implementations both electrodes can be made of a mixture of a nanoporous carbon and a metal oxide material. Various methods can be employed to apply the active electrode layer onto a metal foil that is used as a current collector. The most widely utilized method includes preparing a slurry comprising a mixture of an active electrode material and a binder followed by (a) extrusion and rolling processes, if polytetrafluoroethylene (PTFE) is used as a binder, or (b) coating, drying and calendering processes, if various soluble binders are used. Al so known in the art is a method of electrostatic spray deposition (Li and Wang. J., Mater. Chem. A, 2013, 1, 165-182) for forming an electrode for Li-ion batteries, the method is based on applying a high DC voltage to generate a high electrostatic force and accelerate liquid droplets at the tip of a nozzle. The aerosol formed from charged droplets is sequentially deposited on a heated substrate to create an electrode.

These methods, rolling or coating, or spray deposition, can be termed as “wet” methods, since they involve liquid solvents that have to be thoroughly removed from the porous electrode matrix before fabricating an energy storage device. The solvent removal process typically requires the use of deep vacuum and elevated temperatures to be applied for a long time, which makes the electrode manufacturing process rather complicated and expensive. Besides, in a wet manufacturing process various impurities may be absorbed by the electrode, which can then affect the operational life of the energy storage device. A production method disclosed herein relies on a dry process and can be used for manufacturing an electrode for an EDLC or a hybrid device. The utilized dry process enables depositing the electrode layers on both sides of a substrate—the current collector foil, without involving any liquids.

### SUMMARY

In some aspects, the present teachings provide for a method for manufacturing an electrode for an energy storage device. The method may include the steps of preparing a dry mixture of an active electrode material and a binder, creating a carrying gas flow from a nozzle, creating an electric field between a current collector and the nozzle installed at a predetermined distance from a side of the current collector, introducing the dry mixture into the carrying gas flow to form a jet of particles from the nozzle against the current collector, and depositing the dry mixture onto a current collector surface as to form a layer of said mixture. The active electrode material may be a nanoporous carbon powder, or a metal oxide powder, or their mixture. The method may also include moving the current collector and the nozzle relative to each other. The dry mixture may also contain electrically conductive particles, which may include carbon black or graphite or both. The binder may contain a polymer, such as polyvinylidene fluoride (PVdF), carboxymethyl cellulose, or polyvinyl alcohol. The electric field may be created by a source of high voltage in the range from about 1 kV to about 100 kV. The method may also include positioning an additional electrode between the nozzle and the current collector, and applying an electric voltage in the range from about 1 kV to about 100 kV between the current collector and the additional electrode (pole). The current collector may, for example, be a foil made of aluminum, or copper, or nickel or a conductive rubber film. The current collector surface may be smooth or rough. The current collector surface may be pre-coated with a sub-layer of electrically conductive particles, which may be locally fused into the current collector surface. The carrying gas may, for example, be dried air or an inert gas. The dry mixture may contain particles of about 0.1 micron to about 50 microns in size. The active electrode material and the binder in the dry mixture may, for example, be in a ratio from about 20:1 to about 5:1. The carrying gas flow can be created from a gas source, which has a gas pressure from about 0.5 to about 7 atm, for example. The nozzle may be of various shapes, for example a circle, an oval or a slit, with the cross area from about 2 to about 500 sq. mm. The method may also include increasing the density of the layer deposited on the current collector surface by passing through a calender heated, for example, up to a temperature between about 100 and about 250 deg. C. The method may also include the steps of creating a second carrying gas flow from a second nozzle, installing the second nozzle at a predetermined distance from a second side of the current collector; creating an electric field between the current collector and the second nozzle, introducing the dry mixture into the second carrying gas flow to form a second jet of particles from the second nozzle against a second surface of the current collector, and thus depositing the dry mixture onto both surfaces of the current collector.

In some aspects, the present teachings provide for an electrode manufactured by a process which includes any disclosed herein method for manufacturing an electrode for an energy storage device. For example, the present teachings provide for an electrode for an energy storage device which is manufactured by a process which includes a method including the steps of preparing a dry mixture of an active electrode material and a binder, creating a carrying gas flow from a nozzle, creating an electric field between a current collector and the nozzle installed at a predetermined distance from the current collector, introducing the dry mixture into the carrying gas flow to form a jet of particles from the nozzle against the current collector, and depositing the dry mixture onto a current collector surface as to form a layer of the mixture.

In some aspects, the present teachings provide for a method of choosing an electrostatic field force and a regime of exposition duration and speed of relative movement of a substrate and a nozzle to realize manufacturing of a mechanically stable electrode layer of a predetermined thickness on a current collector surface.

In some aspects, the present teachings provide for an electrode formed on one or both sides of a current collector foil. The electrode layer density can be increased by passing through a calender.

### BRIEF DESCRIPTION OF THE DRAWINGS

The present teachings are illustratively shown and described in reference to the following drawings, in which:

FIG. 1 illustrates a general scheme of the “vertical one-side deposition” version of the method of the present teachings, wherein: 1 designates a compressing station for providing gas flow; 2 designates a feeder for dry powdered mixture; 3 designates a nozzle; 4 designates a pole of high DC voltage; 5 designates a high DC voltage supply; and 6 designates an opposite pole of high DC voltage (substrate);

FIG. 2 illustrates a general scheme of the “vertical two-side deposition” version of the method of the present teachings, wherein: 1 designates a compressing station for providing gas flow; 2-a and 2-b designate feeders for dry powdered mixture; 3-a and 3-b designate nozzles; 4-a and 4-b designate poles of high DC voltage; 5 designates a high DC voltage supply; and 6 designates a grounded pole of high DC voltage (substrate); and

FIG. 3 illustrates a general scheme of the “horizontal one-side deposition” version of the method of the present teachings, wherein: 1 designates a feeder for dry powdered mixture; 2 designates a slit through which the powdered mixture can pour onto the horizontal substrate; 3 designates a high DC voltage supply; 4 designates a pole of high DC voltage; and 5 designates an opposite pole of high DC voltage (substrate).

### DETAILED DESCRIPTION

The present teachings are illustrated in more detail through Examples below. It should be understood, however, that the present teachings are not limited to the embodiments disclosed in the Examples but can as well be embodied utilizing other processes, forms and devices without departing from the scope and spirit of the present teachings.

### Example 1

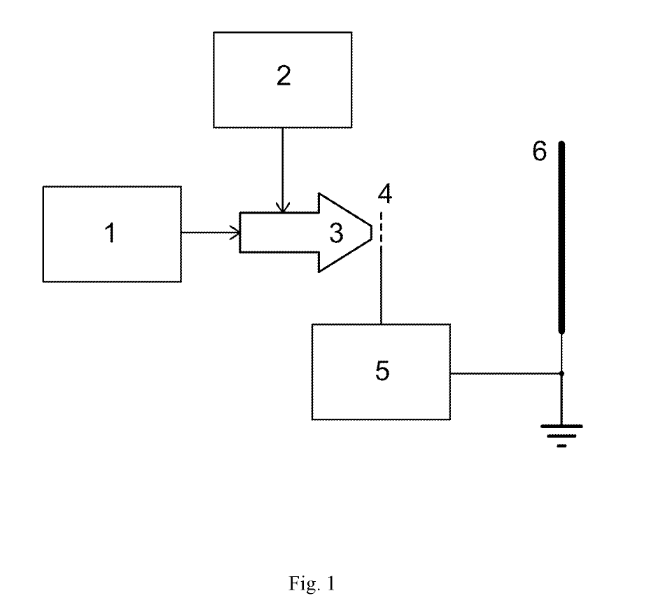

With reference to FIG. 1, a dry nanoporous carbon (YP80F, Kuraray Chemical Co., Ltd) and polyvinyliden fluoride (PVdF, Kynar 900) powders in a ratio of 9 to 1 by mass were thoroughly mixed in a ball mill and placed in feeder 2 to be then introduced into nozzle 3. The airflow from compressing station 1 was also directed into nozzle 3 under a pressure of 5 atm. With continued reference to FIG. 1, a jet of dry particles thus formed was directed onto a surface of aluminum foil of about 20 microns thick (substrate 6) as a result of the DC electrostatic field formed by high DC voltage supply 5 between poles 4 and 6. Specifically, in this experiment pole 4 had a negative potential of 35 kV, while the positive pole of source 5 was connected to substrate 6 and grounded. The distance between nozzle 3 and substrate was about 40 cm, and the rate of their relative displacement was about 5 cm/s. The gas flow and the high voltage were switched on simultaneously. Exposure duration was about 20 s. As a result, a dry mixture of carbon and PVdF particles was deposited on the aluminum foil surface to form an electrode layer, which was then calendered to yield an electrode of about 50 microns thick and about 0.52 g/cm³ dense.

### Example 2

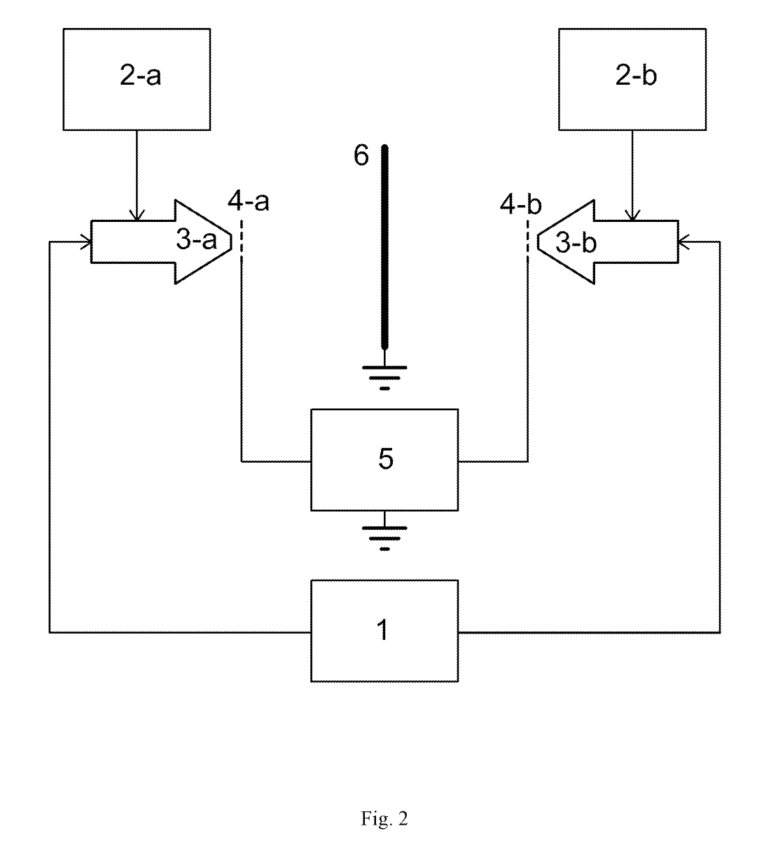

With reference to FIG. 2, a dry nanoporous carbon (YP50F, Kuraray Chemical Co., Ltd) and polyvinyliden fluoride (PVdF, Solef 6020) powders were thoroughly mixed in a ratio of 7 to 1 by mass in a ball mill and placed in feeders 2-a and 2-b to be then introduced into nozzles 3-a and 3-b. The airflow from compressing station 1 was also directed into nozzles 3-a and 3-b under pressure of about 3 atm. With continued reference to FIG. 2, two jets of dry particles thus formed were directed onto both surfaces of aluminum foil of 20 microns thick

Attorney Docket No.: AV-003-US (substrate 6) as a result of the DC electrostatic fields formed by high DC voltage supply 5 between poles 4-a and 4-b and substrate 6. In this experiment poles 4-a and 4-b had a negative potential of about 25 kV, while the positive pole of source 5 was connected to substrate 6 and grounded. The distance between nozzles 3-a, 3-b and substrate 6 was about 30 cm, and the rate of their relative displacement was about 5 cm/s. The gas flow and the high voltage were switched on simultaneously. Exposure duration was about 10 s. As a result, a dry mixture of carbon and PVdF particles was deposited on both sides of the aluminum foil to form two active electrode layers, which were then calendered to yield an electrode of about 60 microns thick total with two active carbon layers of about 20 microns thick and about 0.56 g/cm³ dense each.

### Example 3

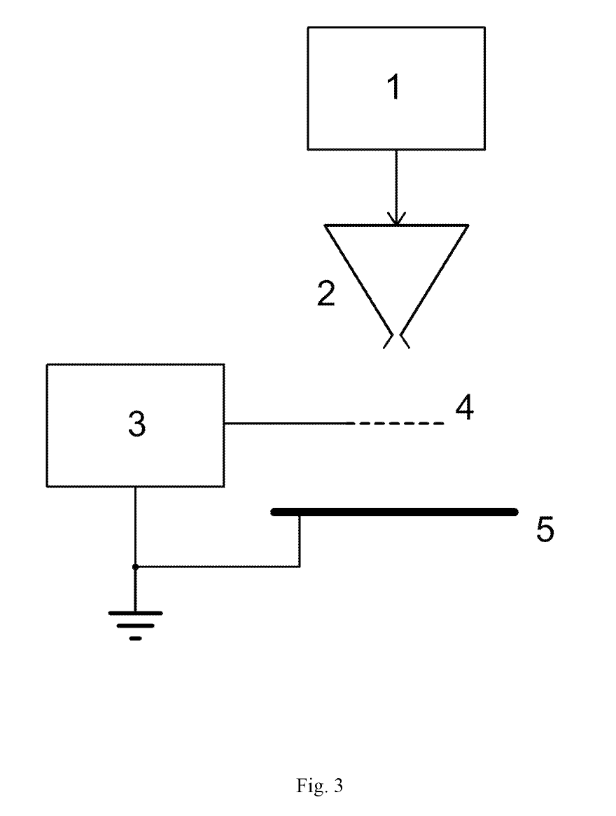

With reference to FIG. 3, a dry nanoporous carbon (YP80F, Kuraray Chemical Co., Ltd), lithium titanate (Li₄Ti₅O₁₂, Phostech Lithium), carbon black (SuperP-Li, Timcal) and polyvinyliden fluoride (PVdF, Kynar 900) powders in a ratio of 2:6:1:1, respectively, by mass were thoroughly mixed in a ball mill and placed in feeder 1 to be then introduced into slit 2. With continued reference to FIG. 3, dry particles poured out of slit 2 were directed onto a surface of aluminum foil of about 15 microns thick (substrate 5) as a result of the DC electrostatic field formed by high DC voltage supply 3 between poles 4 and 5. Specifically, in this experiment pole 4 had a negative potential of 45 kV, while the positive pole of source 3 was connected to substrate 5 and grounded. The distance between pole 4 and substrate was about 35 cm, and the rate of the substrate displacement was about 5 cm/s. Exposure duration was about 30 s. As a result, a dry mixture of carbon, lithium titanate, carbon black and PVdF particles was deposited on the aluminum foil surface to form an electrode layer, which was then calendered to yield an electrode of about 70 microns thick and about 1.70 g/cm³ dense.

To test the mechanical strength of the electrodes manufactured as disclosed in the foregoing, the electrodes were driven/bent at an angle exceeding 90° over a bolt of about 2 mm in diameter, and no electrode damage or separation of the active carbon layer from the aluminum foil were observed.

A set of EDLC prototypes was manufactured using active carbon electrodes that were made as described in Example 1 above. Each electrode had dimensions of about 50×30 mm. To assemble a prototype, one positive electrode and one negative electrode were spaced with a thin porous separator interposed between them, impregnated with an electrolyte containing about 1.3 mol/l of triethylmethylammonium tetrafuoroborate (TEMA BF4) in acetonitrile, and hermetically sealed inside a shell made of aluminum foil laminated with polypropylene. The EDLC prototypes thus made had capacitance of about 2 F and DC resistance of about 55 mOhm.

Those skilled in the art can appreciate from the foregoing description that the present teachings can be implemented in a variety of forms. Therefore, while these teachings have been described in connection with particular embodiments and examples thereof, the true scope of the present teachings should not be so limited. Various changes and modifications may be made without departing from the scope of the teachings herein.

What is claimed is:

1. A method for manufacturing an electrode for an energy storage device, the method comprising the steps of:
preparing a dry mixture of an active electrode material and a binder;
creating a carrying gas flow from a nozzle;
creating an electric field between a current collector and the nozzle installed at a predetermined distance from the current collector;
introducing the dry mixture into the carrying gas flow to form a jet of particles from the nozzle against the current collector; and
depositing the dry mixture onto a current collector surface as to form a layer of said mixture.

2. The method of claim 1, further comprising increasing the density of said layer of said mixture by passing through a calender.

3. The method of claim 1, wherein the active electrode material is a nanoporous carbon powder, or a metal oxide powder, or a mixture thereof.

4. The method of claim 1, further comprising moving the current collector and the nozzle relative to each other.

5. The method of claim 1, wherein said preparing of the dry mixture further comprises adding electrically conductive particles thereto.

6. The method of claim 5, wherein carbon black is used as the electrically conductive particles.

7. The method of claim 1, wherein the binder comprises a polymer, such as polyvinylidene fluoride (PVdF), carboxymethyl cellulose, or polyvinyl alcohol.

8. The method of claim 1, wherein said electric field is created by a source of high voltage in the range from about 1 kV to about 100 kV.

9. The method of claim 8, further comprising positioning an additional electrode between the nozzle and the current collector, and applying an electric voltage in the range from about 1 kV to about 100 kV between the current collector and the additional electrode.

10. The method of claim 1, wherein the current collector is a foil made of aluminum, or copper, or nickel or a conductive rubber film.

11. The method of claim 1, wherein the current collector surface is smooth or rough.

12. The method of claim 1, wherein the current collector surface is pre-coated with a sub-layer of electrically conductive particles, preferably locally fused into the current collector surface.

13. The method of claim 1, wherein the carrying gas is dried air or an inert gas.

14. The method of claim 1, wherein the dry mixture comprises particles of about 0.1 micron to about 50 microns in size.

15. The method of claim 1, wherein the active electrode material and the binder are in a ratio from about 20:1 to about 5:1.

16. The method of claim 1, wherein the carrying gas flow is created from a gas source having gas pressure from about 0.5 to about 7 atm.

17. The method of claim 1, wherein the nozzle is circular, oval or slit-shaped, and has a cross area from about 2 to about 500 mm².

18. The method of claim 1, further comprising the steps of:
creating a second carrying gas flow from a second nozzle;
installing the second nozzle at a predetermined distance from a second side of the current collector;
creating an electric field between the current collector and the second nozzle;
introducing the dry mixture into the second carrying gas flow to form a second jet of particles from the second nozzle against a second surface of the current collector; and
depositing the dry mixture onto the second surface.

19. An electrode for an energy storage device, said electrode is manufactured by a process comprising a method comprising the steps of:
preparing a dry mixture of an active electrode material and a binder;
creating a carrying gas flow from a nozzle;
creating an electric field between a current collector and the nozzle installed at a predetermined distance from the current collector;
introducing the dry mixture into the carrying gas flow to form a jet of particles from the nozzle against the current collector; and
depositing the dry mixture onto a current collector surface as to form a layer of said mixture.
